(19) United States
(12) Patent Application Publication
(10) Pub. No.: US 2021/0204721 A1
(43) Pub. Date: Jul. 8, 2021

(54) MAGNETIC MAT WITH REMOVABLE COVER HAVING ROTATING MAGNETS

(71) Applicant: Shutida Srikanchana, Atlanta, GA (US)

(72) Inventor: Shutida Srikanchana, Atlanta, GA (US)

(21) Appl. No.: 17/143,138

(22) Filed: Jan. 6, 2021

Related U.S. Application Data
(60) Provisional application No. 62/957,794, filed on Jan. 6, 2020.

(51) Int. Cl. A47C 31/00; F16B 1/00; A47C 13/00; A47D 11/00; A63G 31/00

(52) U.S. Cl. CPC A47C 31/003; F16B 1/00; F16B 2001/0035; A47D 11/00; A63G 31/00; A47C 13/005

(57) ABSTRACT

Implementations of a magnetic mat with removable cover having rotating magnets (“magnetic mat”) are provided. In some implementations, the magnetic mat comprises an insert, a cover, pockets, and magnets.

In some implementations, a method for using the magnetic mat comprises assembling two or more of the magnetic mats together in a desired shape configuration.

In some implementations, the method may further comprise disassembling the magnetic mats from the assembled shape configuration. In some implementations, the method may further comprise reassembling the magnetic mats into another desired shape configuration.

### CROSS REFERENCE TO RELATED APPLICATION

This application claims the benefit of U.S. Patent Application Ser. No. 62/957,794, which was filed on Jan. 6, 2020, and is incorporated herein by reference in its entirety.

### TECHNICAL FIELD

This disclosure relates to implementations of a magnetic mat with removable cover having rotating magnets (“magnetic mat”) and method of using the same.

### BACKGROUND

Prisms are three-dimensional geometric shapes (or figures) that have many applications. For example, some prisms are often used for reading magnification or to bend or spread light waves for decorative or scientific uses. Prisms may also be used for recreational purposes, such as to form the shape of a recreational play area for younger children or activity/challenge area for older children or adults. In this regard, FIGS. 8, 10, and 12 illustrate implementations of example complex shape configurations (e.g., three dimensional) that can be used as such recreational areas according to the present disclosure, which are described below. Furthermore, prisms may be used for other applicable purposes, such as to create artwork such as sculptures.

However, there does not currently exist padded mats that are configured to be assembled and reassembled to form complex-configurations for recreational purposes as described above or for other applicable uses.

To further describe and exemplify prism shapes, FIGS. 13-15 illustrate annotated diagrams of various example prisms. As shown in FIG. 13, a prism is a polyhedron (i.e., a multi-face/multi-side figure) that has two congruent (i.e., same size and shape) parallel faces, which are called bases. The other faces of a prism are called lateral faces.

A prism is usually named or described based on the shape of the bases of the prism. For example, as shown in FIG. 13 from left to right, a pentagonal prism (based on the pentagonal shaped bases) and a triangular prism (based on the triangular shaped bases) is shown respectively.

As shown in FIG. 14, the bases of a prism are congruent polygons (i.e., any shape having three or more straight sides in the same plane) that lie in parallel planes, i.e. the bases are congruent and parallel to each other. As also shown in FIG. 14, the height of a prism is called the altitude and is represented by the length of a line extending perpendicularly between the bases.

As shown in FIG. 15, the lateral faces of a prism connect the corresponding vertices of the bases and extend between the sides/edges of the bases. As also shown in FIG. 15, the lateral edges of a prism are segments (or line segments) that connect the lateral faces, i.e. the lateral faces also extend between the lateral edges. Thus, the lateral faces may have any size and shape so that the lateral faces extend between the base edges and the lateral edges as described.

### BRIEF DESCRIPTION OF THE DRAWINGS

FIGS. 1-5 illustrate various views of implementations of an example magnetic mat according to the present disclosure.

FIGS. 6 and 7 illustrate diagram representations of the example magnetic mat according to the present disclosure.

FIGS. 8-11 illustrate implementations of example complex shape configurations assembled from a plurality of the magnetic mats according to the present disclosure.

FIG. 12 illustrates diagram representations of other example complex shape configurations assembled from a plurality of the magnetic mats according to the present disclosure.

FIGS. 13-15 illustrate annotated diagrams of various example prisms.

### DETAILED DESCRIPTION

Implementations of a magnetic mat are provided. In some implementations, the magnetic mat comprises an insert made from a first material, at least one magnet, and a cover made from a second material. In some implementations, the cover is configured to enclose the insert and the at least one magnet. In some implementations, the insert and the cover form a N-sided three-dimensional shape having a first base surface with N sides, a second base surface having N sides, and N lateral face surfaces wherein N is greater than or equal to three wherein the first base surface and the second base surface are on opposite sides of the mat and for each side of the N-sided three-dimensional shape, a lateral face extends widthwise between the edges of the first base surface and the second base surface and lengthwise from a first end of the side of the N-sided three-dimensional shape to a second end of the side of the N-sided three-dimensional shape. In some implementations, the cover further comprises at least one pocket in a position coinciding with at least one of the lateral face surfaces wherein the at least one magnet is contained within the at least one pocket and the pocket is sized and shaped such that the at least one magnet is moveable widthwise and lengthwise along at least a part of the lateral face surface. In some implementations, the at least one magnet is a rotating magnet and the pocket is sized and shaped such that the at least one magnet can rotate along an axis to line up with a nearby magnet.

In some implementations, the lateral face extends lengthwise 17.5 inches or more. In some implementations, the lateral face extends lengthwise less than 17.5 inches. In some implementations, the lateral face extends lengthwise about or around 18 inches due to manufacturing variances.

In some implementations, the lateral face extends widthwise 1 inch or more. In some implementations, the lateral face extends widthwise less than 1 inch. In some implementations, the lateral face extends widthwise about or around 1 inch due to manufacturing variances.

In some implementations, the magnetic mat is configured to connect together in a shape configuration comprising two or more of the magnetic mats.

In some implementations, the magnetic mat is configured to magnetically connect together two or more of the magnetic mats to form various shaped configurations ranging from simple to complex.

In some implementations, the magnetic mat is configured so that two or more of the magnetic mats can be magnetically connected together by the respective magnets.

In some implementations, the magnetic mat is configured so that two or more of the magnetic mats can be magnetically connected together to build complex shapes and structures.

In some implementations, the magnetic mat is configured so that two or more of the magnetic mats can be assembled and reassembled to form complex configurations such as 2 and 3-dimensional configurations.

In some implementations, the magnetic mat is configured so that two or more of the magnetic mats can be assembled and reassembled to form complex shape configurations for use as recreational play areas or activity/challenge areas.

In some implementations, the magnetic mat is configured so that two or more of the magnetic mats can be assembled and reassembled to form complex shape configurations for any other suitable uses.

In some implementations, a method for using the magnetic mat comprises assembling two or more of the magnetic mats together in a desired shape configuration.

In some implementations, the method may further comprise using the shape configuration formed by the assembled magnetic mats.

In some implementations, the method may further comprise disassembling the magnetic mats from the assembled shape configuration.

In some implementations, the method may further comprise reassembling the magnetic mats into another desired shape configuration.

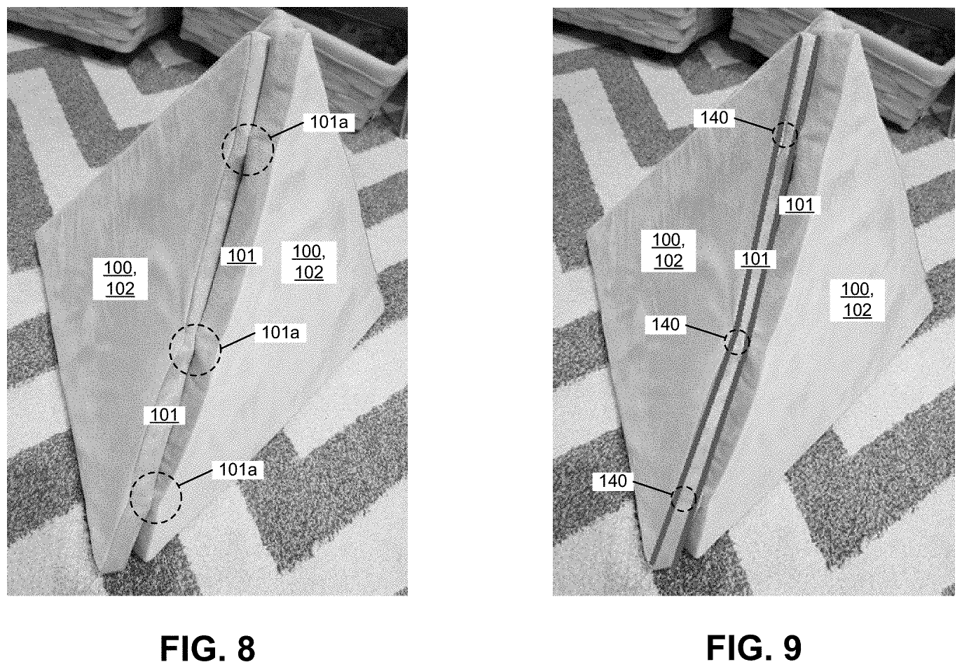

Prisms are three-dimensional geometric shapes (or figures) that have many applications. For example, some prisms are often used for reading magnification or to bend or spread light waves for decorative or scientific uses. Prisms also may be used for recreational purposes, such as to form the shape of a recreational play area for younger children or activity/challenge area for older children or adults. In this regard, FIGS. 8, 10, and 12 illustrate implementations of example complex configurations that can be used as such recreational areas according to the present disclosure, which are described below. Furthermore, prisms may be used for other applicable purposes, such as to create artwork such as sculptures.

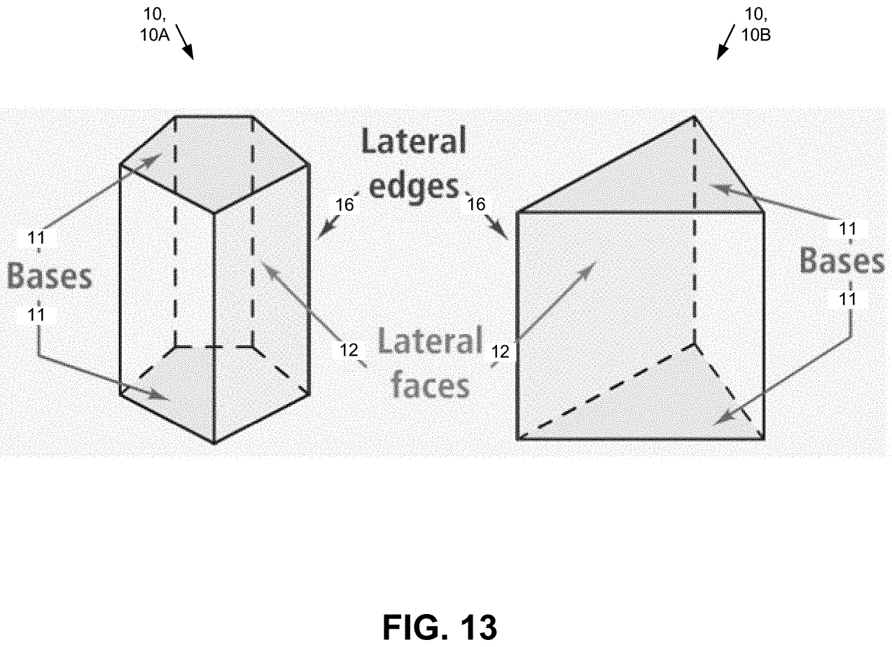

FIGS. 13-15 illustrate annotated diagrams of various example prisms 10. As shown in FIG. 13, a prism 10 is a polyhedron (i.e., a multi-face/multi-side figure) that has two congruent (i.e., same size and shape) parallel faces 11, which are called bases 11. The other faces 12 of a prism 10 are called lateral faces 12.

A prism 10 is usually named or described based on the shape of the bases 11 of the prism 10. For example, as shown in FIG. 13 from left to right, a pentagonal prism 10A (based on the pentagonal shaped bases) and a triangular prism 10B (based on the triangular shaped bases) is shown respectively.

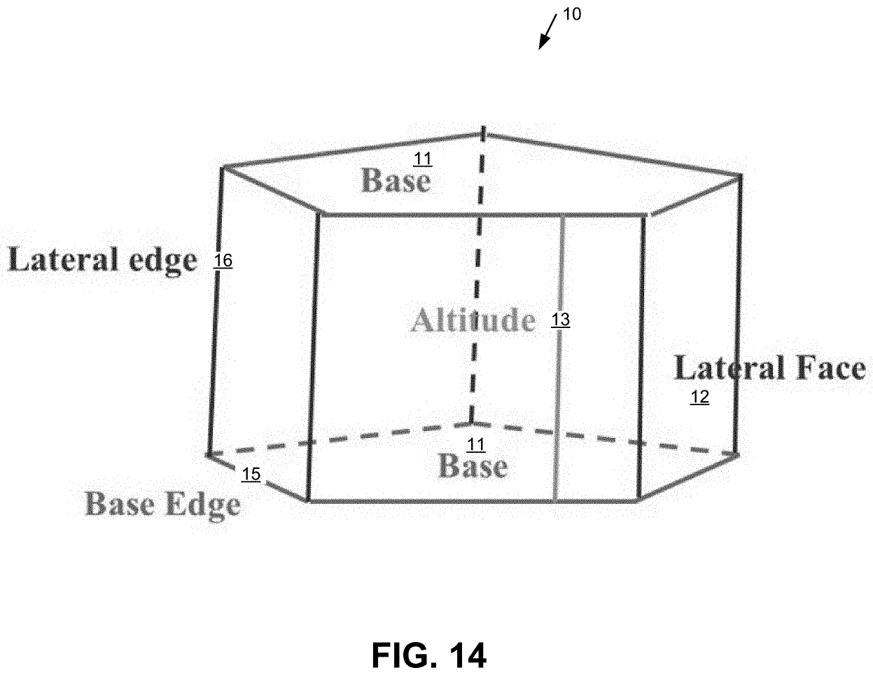

As shown in FIG. 14, the bases 11 of a prism 10 are congruent polygons (i.e., any shape having three or more straight sides in the same plane) that lie in parallel planes, i.e. the bases 11 are congruent and parallel to each other. As also shown in FIG. 14, the height of a prism 10 is called the altitude and is represented by the length of a line 13 extending perpendicularly between the bases 11.

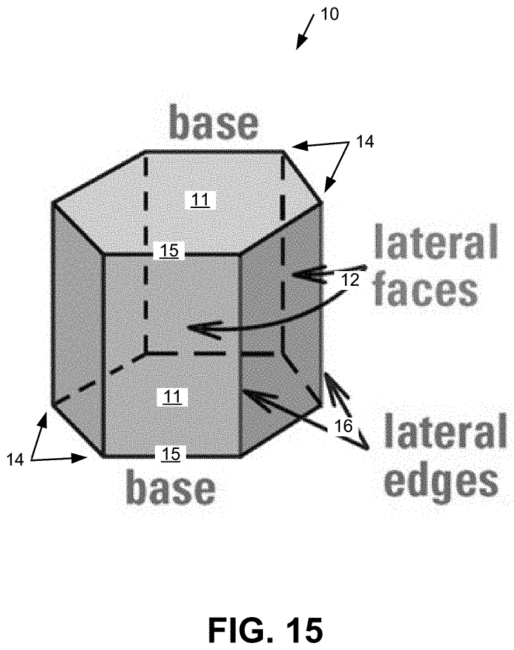

As shown in FIG. 15, the lateral faces 12 of a prism 10 connect the corresponding vertices 14 of the bases 11 and extend between the sides/edges 15 of the bases 11. As also shown in FIG. 15, the lateral edges 16 of a prism 10 are segments (or line segments) that connect the lateral faces 12, i.e. the lateral faces 12 also extend between the lateral edges 16. Thus, the lateral faces 12 may have any size and shape so that the lateral faces 12 extend between the base edges 15 and the lateral edges 16 as described.

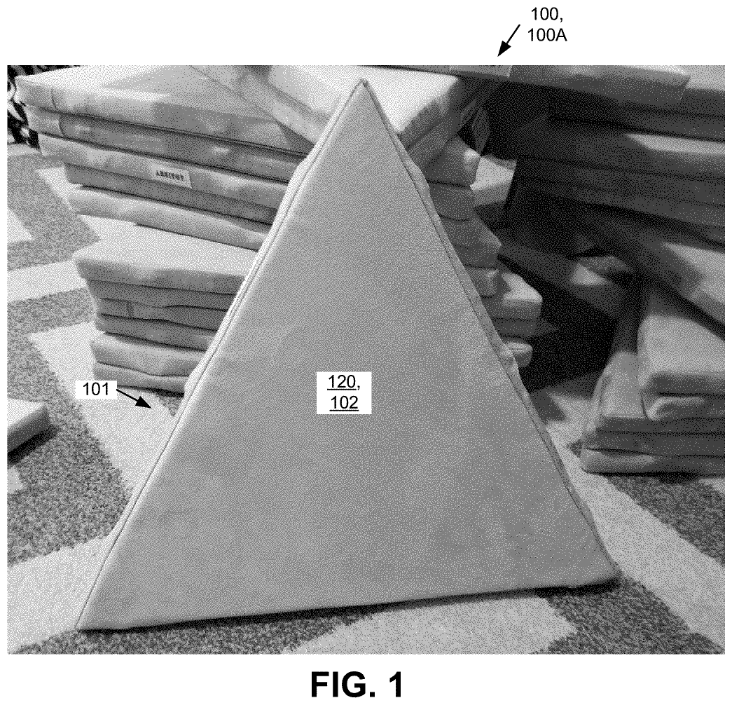

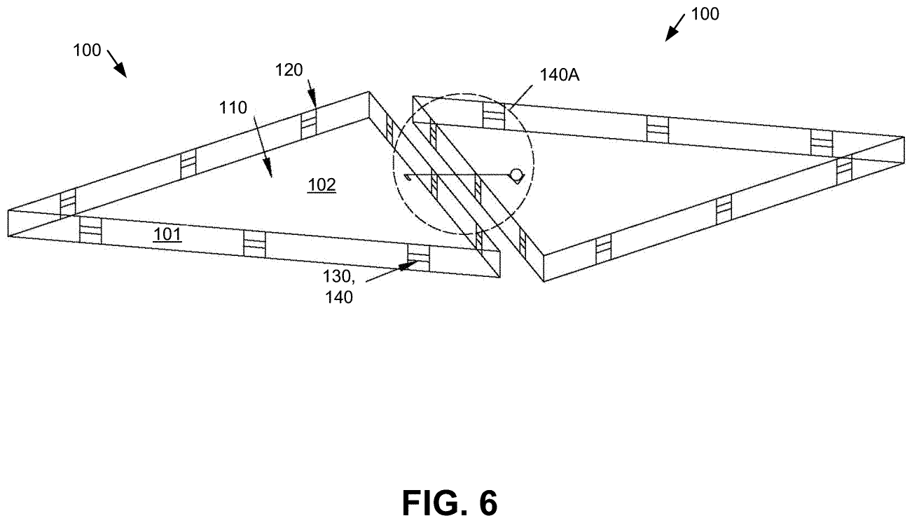

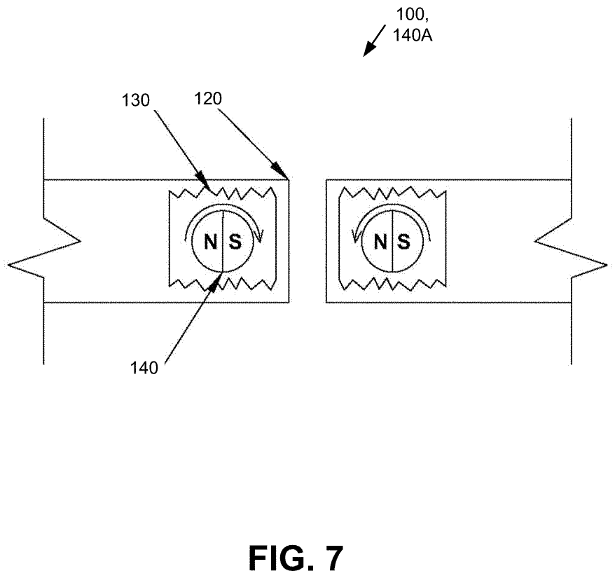

FIGS. 1-5 illustrate various views of implementations of an example magnetic mat with removable cover having cylindrical magnets (“magnetic mat”) 100 according to the present disclosure. FIGS. 6 and 7 illustrate diagram representations of the example magnetic mat 100 according to the present disclosure.

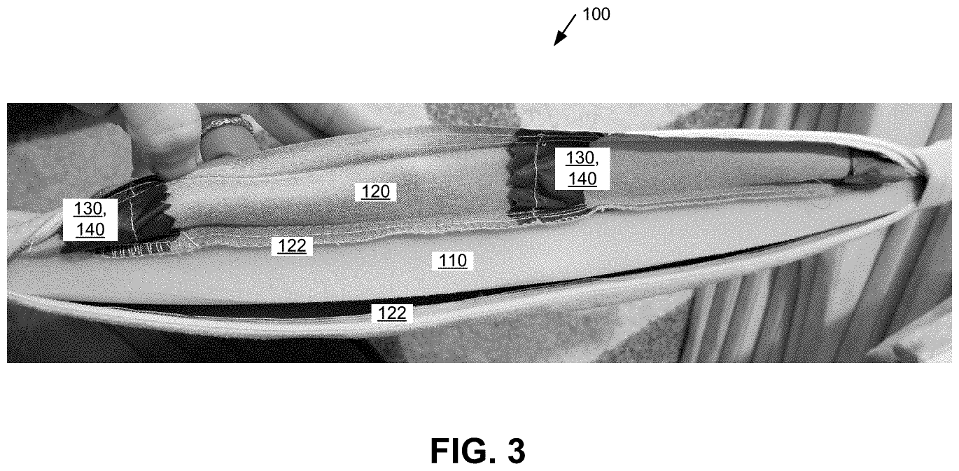

As shown in FIG. 3, in some implementations, the magnetic mat 100 comprises an insert 110, a cover 120, pockets 130, and magnets 140.

In some implementations, the insert 110 is an internal (or interior) part of the magnetic mat 100. As shown in FIG. 3, in some implementations, the insert 110 is positioned or otherwise contained within the cover 120.

In some implementations, the insert 110 comprises a pad, padding, or a cushion. In some implementations, the insert 110 may comprise a hard agent or similar firmer component. In some implementations, the insert 110 may comprise any other suitable component.

In some implementations, the insert 110 comprises a three-dimensional shape, such as a prism shape described above with respect to FIGS. 13-15. For example, in some implementations, the insert 110 comprises a triangular prism shape comprising two congruent, parallel triangular bases bounded by rectangular lateral faces. In some implementations, the insert 110 thereby comprises a triangular prism shape that is the same or similar to the triangular prism shaped magnetic mat 100 shown in FIG. 1, 2, or 6, described below. As another example, in some implementations, the insert 110 comprises a cube shape.

In some implementations, the insert 110 may comprise any other suitable shape, such as any other suitable prism shape.

In some implementations, the shape of the insert 110 forms the shape of the magnetic mat 100, such as the above-described three-dimensional shape. Alternately, in some implementations, the shape of the insert 110 is based on the shape of the cover 120, which thereby forms the shape of the magnetic mat 100.

In some implementations, the insert 110 is composed of a foam material. For example, in some implementations, the insert 110 may be composed of a polyurethane foam material. In some implementations, the insert 110 may be composed of a polyethylene foam material.

In some implementations, the foam material may be a medium density foam material. In some implementations, the foam material may be a high density foam material.

In some implementations, the insert 110 may be composed of any other suitable material.

In some implementations, the insert 110 is configured to have a three-dimensional shape, such as a prism shape described above with respect to FIGS. 13-15. For example, in some implementations, the insert 110 is configured to have a triangular prism shape that is the same or similar to the triangular prism shaped magnetic mat 100 shown in FIG. 1, 2, or 6, described below.

In some implementations, the insert 110 is configured to form the shape of the magnetic mat 100, such as the above-described three-dimensional shape. Alternately, in some implementations, the insert 110 may be configured to fit within the shape of the cover 120, which thereby forms the shape of the magnetic mat 100.

In some implementations, the insert 110 is configured to be contained or otherwise positioned within the cover 120. In some implementations, the insert 110 is configured to be removable or otherwise separable from the cover 120.

In some implementations, the insert 110 is configured to provide a padding or cushioning feature of the magnetic mat 100. In some implementations, the insert 110 may be configured to provide a supporting and/or stiffening feature of the magnetic mat 100. In some implementations, the insert 110 may be configured to provide any other suitable feature of the magnetic mat 100.

In some implementations, the cover 120 is an external (or exterior) part of the magnetic mat 100. As shown in FIG. 3, in some implementations, the cover 120 covers or otherwise encloses the insert 110 within the cover 120.

As described below, in some implementations, the cover 120 may comprise one or more openings 122 for receiving and removing the insert 110 from the cover 120.

In some implementations, the cover 120 comprises a configuration of material forming an enclosure for receiving the insert 110 within the cover 120. For example, in some implementations, the cover 120 is configured to receive the insert 110 having a three-dimensional shape, such as a prism shape described above with respect to FIGS. 13-15. In some implementations, the cover 120 is configured to receive the insert 110 having a triangular prism shape that is the same or similar to the triangular prism shaped magnetic mat 100 shown in FIG. 1, 2, or 6, described below.

In some implementations, the cover 120 may be configured to receive an insert 110 having any other suitable shape, such as any other suitable prism shape.

As shown in FIGS. 3 and 6, and described more below, in some implementations, the one or more pockets 130 of the magnetic mat 100 are attached to the cover 120 along portions of the cover 120 that correspond to one or more of the lateral faces 101 of the magnetic mat 100 (i.e., when the insert 110 is contained within the cover 120).

In some implementations, the shape of the cover 120 conforms to the shape of the insert 110 when the insert 110 is received within the cover 120. That is, in some implementations, the cover 120 is configured to be coextensive with (e.g., stretchable or otherwise extendable over) the insert 110 when received within the cover 120. In some implementations, the cover 120 is so configured such that the combination of the cover 120 containing the insert 110 forms the magnetic mat 100 having a three-dimensional (e.g., prism) shape, wherein the cover 120 forms the exterior of the magnetic mat 100 and the insert 110 forms the interior of the magnetic mat 100.

Alternately, in some implementations, the shape of the cover 120 may be separately formed the same or similar to the shape of the insert 110. In some implementations, the shape of the cover 120 may be so formed such that the insert 110 can be enclosed or removed from the cover 120 with little or no stretching or other change in the shape of the cover 120 (i.e., the shape of the cover 120 may be pre-formed).

In some implementations, the cover 120 is configured to receive and/or otherwise contain the insert 110 within the cover 120, such as described above.

In some implementations, the cover 120 is configured to be removable or otherwise separable from the insert 110. For example, as shown in FIG. 3, in some implementations, the cover 120 may comprise an opening 122 through which the insert 110 can be received and removed from the cover 120. In some implementations, the cover 120 may also comprise any suitable closure (not shown) for the opening 122, wherein the closure allows the insert 100 to be enclosed within or removed from the cover 120.

In some implementations, the cover 120 may be configured to provide a protecting feature of the magnetic mat 100, such as to protect the insert 110 and/or other components of the magnetic mat 100 from damage, dirtiness, moisture, etc.

In some implementations, the cover 120 may be configured to provide a concealing and/or decorative feature of the magnetic mat 100, such as to conceal and/or decorate the appearance of the insert 110 and/or other components of the magnetic mat 100.

In some implementations, the cover 120 may be configured to provide a supporting and/or stiffening feature of the magnetic mat 100. For example, in some implementations, the cover 120 may comprise a hard agent or stiff (e.g., shell-like) portion to provide such feature.

In some implementations, the cover 120 may be configured to provide any other suitable feature of the magnetic mat 100.

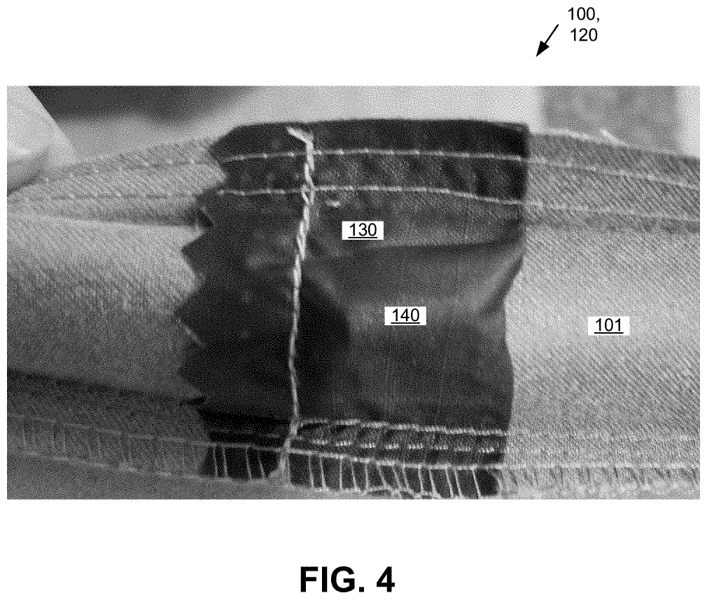

As shown in FIGS. 3 and 4, in some implementations, the pockets 130 each comprise a configuration of material attached to the cover 120 and configured to hold a magnet 140 within the pocket 130.

As shown in FIGS. 3 and 6, in some implementations, the pockets 130 are attached respectively to the cover 120 along the portions of the cover 120 that correspond to the lateral faces 101 of the magnetic mat 100 (i.e., when the insert 110 is contained within the cover 120). As shown in FIGS. 8, 10, and 12, and described more below, in some implementations, this attachment positioning of the pockets 130 allows the positioning of the magnets 140 so that two or more of the magnetic mats 100 can be magnetically connected together by the magnets 140 to form various shaped configurations ranging from simple to complex.

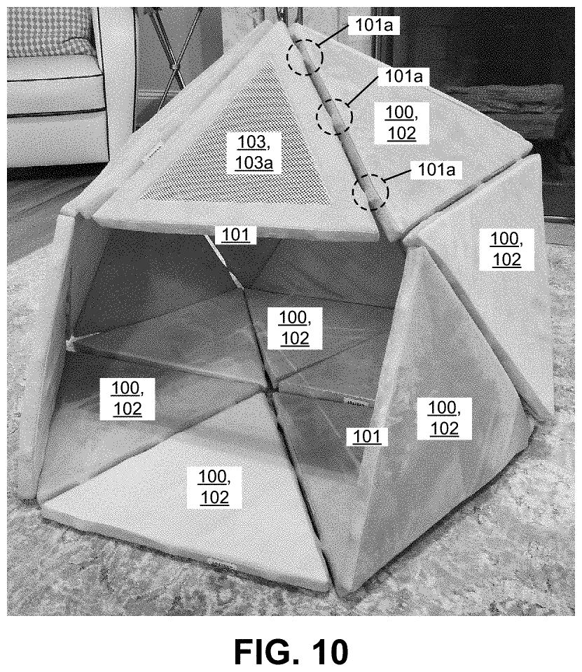

In some implementations, each pocket 130 is configured to house a magnet 140, which may be cylindrical shaped as described below. In this way, as indicated by the markers 101a shown in FIGS. 8 and 10, in some implementations, at least portions of the lateral faces 101 of the magnetic mat 100 are magnetic.

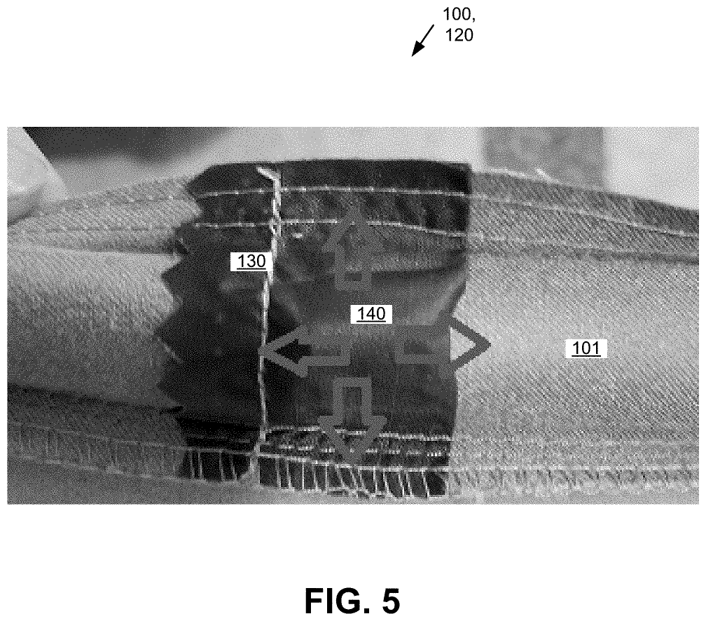

As indicated in FIG. 5, in some implementations, each pocket 130 is configured to allow a magnet 140 contained within the pocket 130 to move laterally (e.g., side to side) and transversely or longitudinally (e.g., upward and downward). As indicated in the zoomed-in view 140A in FIG. 7, in some implementations, each pocket 130 is also configured to allow a magnet 140 contained within the pocket 130 to rotate (e.g., about a virtual axis extending parallel or perpendicular to the adjacent lateral face 101). In this way, in some implementations, the magnet 140 is able to move freely within a respective pocket 130 to allow the magnet 140 to line up with a corresponding magnet 140 of an adjacently positioned magnetic mat 100.

In some implementations, each pocket 130 may be configured to allow a magnet 140 contained within the pocket 130 to move in any other suitable manner.

In some implementations, the pockets 130 are sized to allow a magnet 140 respectively contained therein to move in the above-described manners. For example, in some implementations, the dimensions of the pockets 130 are larger than the corresponding dimensions of the magnets 140 such that the magnets 140 can move respectively in the above-described manners.

In some implementations, the pockets 130 may be shaped to allow a magnet 140 respectively contained therein to move in the above-described manners. In some implementations, the pockets 130 may be configured in any other suitable way to allow a magnet 140 respectively contained therein to move in the above-described manners.

In some implementations, the magnets 140 of the magnetic mat 100 may be any suitable type, configuration, etc. of magnet.

In some implementations, the magnets 140 are cylindrical shaped. In some implementations, the magnets 140 may be any other suitable shape (e.g., spherical or any other shape). In some implementations, the magnets 140 may be any shape that allows the magnet to rotate along an axis to line up with a nearby similar magnet.

As shown in FIGS. 4 and 6, in some implementations, the magnets 140 are each contained or otherwise enclosed within a respective pocket 130 of the magnetic mat 100.

As shown in FIGS. 8 and 10, in some implementations, the magnets 140 are configured to attract together to connect two or more of the magnetic mats 100 together in a shape configuration, as described below.

As indicated in FIG. 5, in some implementations, the magnets 140 are configured to each move laterally (e.g., side to side) and transversely or longitudinally (e.g., upward and downward) within a respective pocket 130 of the magnetic mat 100.

As indicated in FIG. 7, in some implementations, the magnets 140 are configured to each rotate within a respective pocket 130 (e.g., about a virtual axis extending parallel or perpendicular to the adjacent lateral face 101).

In some implementations, the magnets 140 are configured to move freely within a respective pocket 130 (such as in the above-described manners) to allow the magnets 140 to line up respectively with corresponding magnets 140 of an adjacently positioned magnetic mat 100. In this way, in some implementations, two or more of the magnetic mats 100 can be connected together by the magnets 140 in a shape configuration, as described below.

In some implementations, the magnets 140 may be configured to move in any other suitable manner within a respective pocket 130.

As shown in FIGS. 1, 2, and 6, in some implementations, the magnetic mat 100 comprises a three-dimensional shape, such as a prism shape described above with respect to FIGS. 13-15. For example, in some implementations, the magnetic mat 100 comprises a triangular prism shape comprising two congruent, parallel triangular bases 102 bounded by rectangular lateral faces 101.

In some implementations, the magnetic mat 100 may comprise any other suitable shape, such as any other suitable prism shape.

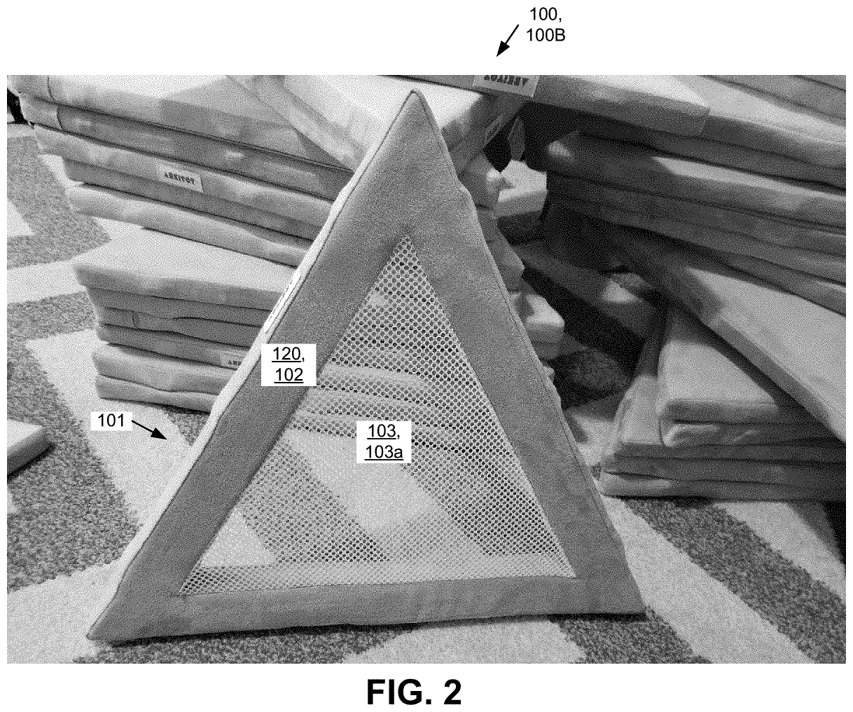

As shown in FIG. 1, in some implementations, the magnetic mat 100 (100A) may comprise a solid triangular prism shape. As shown in FIG. 2, in some implementations, the magnetic mat 100 (100B) may comprise a triangular frame prism shape, e.g., that includes an opening 103 through the bases 102. In some implementations, the insert 110 and cover 120 of the magnetic mat 100B may comprise a corresponding opening, and the cover 120 may comprise a screen or netting 103a across the opening 103.

In some implementations, the magnetic mat 100 may comprise any other suitable shape configuration.

In some implementations, the magnetic mat 100 is configured to have a three-dimensional shape, such as a prism shape described above with respect to FIGS. 13-15. For example, in some implementations, the magnetic mat 100 is configured to have a triangular prism shape as described above.

In some implementations, the magnetic mat 100 may be configured to have any other suitable shape.

As shown in FIGS. 8-12, in some implementations, the magnetic mat 100 is configured to connect together in a shape configuration comprising two or more of the magnetic mats 100.

In some implementations, the magnetic mat 100 is configured to magnetically connect together two or more of the magnetic mats 100 to form various shaped configurations ranging from simple to complex.

In some implementations, the magnetic mat 100 is configured so that two or more of the magnetic mats 100 can be magnetically connected together by the respective magnets 140.

In some implementations, the magnetic mat 100 is configured so that two or more of the magnetic mats 100 can be magnetically connected together to build complex shapes and structures.

In some implementations, the magnetic mat 100 is configured so that two or more of the magnetic mats 100 can be assembled and reassembled to form complex shape configurations.

In some implementations, the magnetic mat 100 is configured so that two or more of the magnetic mats 100 can be assembled and reassembled to form complex shape configurations for use as recreational play areas or activity/challenge areas, such as described above.

In some implementations, the magnetic mat 100 is configured so that two or more of the magnetic mats 100 can be assembled and reassembled to form complex shape configurations for any other suitable uses.

FIGS. 8-11 illustrate implementations of example complex shape configurations assembled from a plurality of the magnetic mats 100 according to the present disclosure.

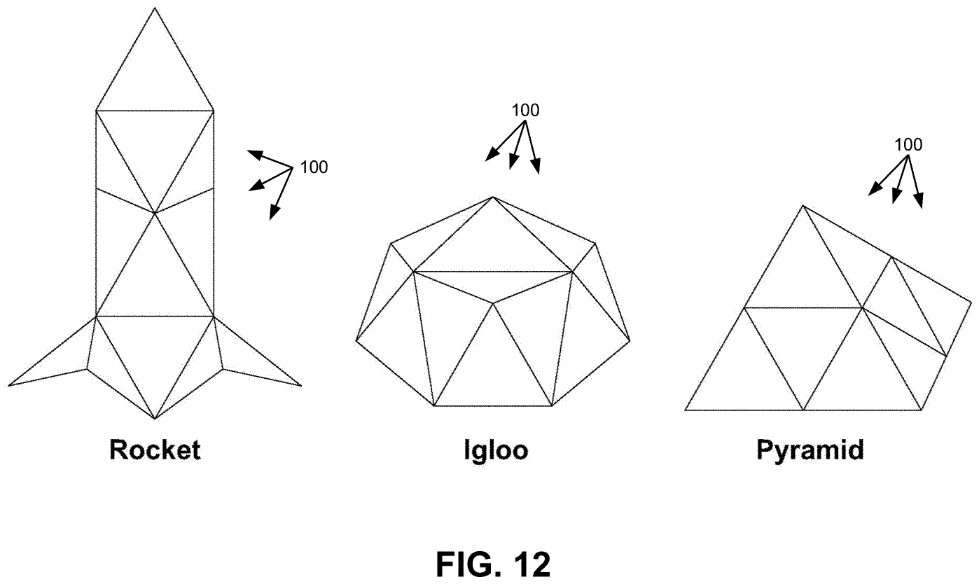

FIG. 12 illustrates diagram representations of other example complex shape configurations assembled from a plurality of the magnetic mats 100 according to the present disclosure.

FIGS. 8 and 9 illustrate an example simple shape configuration comprising a plurality of the magnetic mats 100 assembled in a multi-sided pyramid configuration. FIG. 9 also indicates one of the lateral faces 101 of a triangular prism shaped magnetic mat 100 along which the magnets 140 are positioned.

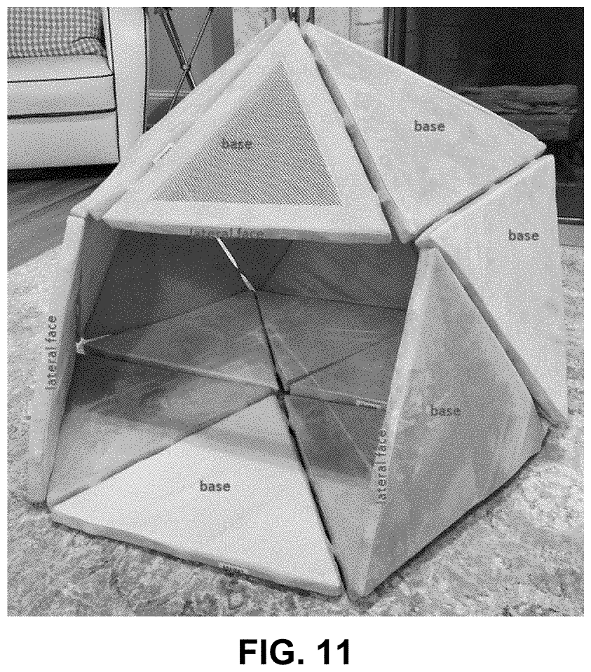

FIGS. 10 and 11 illustrate an example complex shape configuration comprising a plurality of the magnetic mats 100 assembled in a multi-sided igloo configuration. FIG. 11 also labels some of the bases 102 and lateral faces 101 of the triangular prism shaped magnetic mats 100 forming the shape configuration.

FIG. 12 illustrates diagram representations of several other example complex shape configurations comprising a plurality of the magnetic mats 100 assembled together. For example, as shown in FIG. 12 (from left to right), in some implementations, the other example complex shape configurations include a rocket shape configuration, an igloo shape configuration, and a pyramid shape configuration.

In some implementations, the magnetic mat 100 comprises any suitable dimensions.

In some implementations, the magnetic mat 100 is composed of any suitable materials, such as the example materials described above.

In some implementations, the magnetic mat 100 can have any suitable appearance, such as the example appearances shown in the figures.

In some implementations, an example method of using the magnetic mat 100, with respect to the above-described figures, comprises assembling two or more of the magnetic mats 100 together in a desired shape configuration. In some implementations, assembling the magnetic mats 100 comprises connecting the magnetic mats 100 together by joining together the magnets 140 held in the pockets 130 positioned along the lateral faces 101 of the respective magnetic mats 100. In some implementations, the magnets 140 freely move laterally, transversely or longitudinally, and/or rotationally within the pockets 130 to join together and form the desired shape configuration.

In some implementations, the method may further comprise using the shape configuration formed by the assembled magnetic mats 100. For example, in some implementations, the shape configuration may be used for recreation purposes, such as to provide a play area or an activity/challenge area (such as described above). In some implementations, the shape configuration may be used for any other suitable purpose.

In some implementations, the method may further comprise disassembling the magnetic mats 100 from the assembled shape configuration by separating the magnets 140 of the respective magnetic mats 100. In some implementations, the magnetic mats 100 may be disassembled so that the magnetic mats 100 can be used to assemble another shape configuration. In some implementations, the magnetic mats 100 may be disassembled so that the magnetic mats 100 can be moved and/or stored.

In some implementations, the method may further comprise reassembling the magnetic mats 100 into another desired shape configuration, such as in the manner described above for assembling the magnetic mats 100.

The figures, including photographs and drawings, comprised herewith may represent one or more implementations of the magnetic mat with removable cover having rotating magnets (“magnetic mat”).

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A magnetic mat comprising:
an insert made from a first material, at least one magnet, and a cover made from a second material wherein:
the cover is configured to enclose the insert and the at least one magnet;
the insert and the cover form a N-sided three-dimensional shape having a first base surface with N sides, a second base surface having N sides, and N lateral face surfaces wherein N is greater than or equal to three wherein the first base surface and the second base surface are on opposite sides of the mat and for each side of the N-sided three-dimensional shape, a lateral face extends widthwise between the edges of the first base surface and the second base surface and lengthwise from a first end of the side of the N-sided three-dimensional shape to a second end of the side of the N-sided three-dimensional shape;
the cover further comprises at least one pocket in a position coinciding with at least one of the lateral face surfaces wherein the at least one magnet is contained within the at least one pocket and the pocket is sized and shaped such that the at least one magnet is moveable widthwise and lengthwise along at least a part of the lateral face surface; and
the at least one magnet is a rotating magnet and the pocket is sized and shaped such that the at least one magnet can rotate along an axis to line up with a nearby magnet.

2. The magnetic mat of claim 1 wherein the cover is removable and comprises a recloseable opening to receive and remove the insert.

3. The magnetic mat of claim 1 wherein the magnets are cylindrical shaped.

4. The magnetic mat of claim 1 wherein the magnets are spherical shaped.

5. The magnetic mat of claim 1 wherein the insert is a foam material.

6. The magnetic mat of claim 1 wherein the insert and the cover form a cushion.

7. A method of using a first magnetic mat of claim 1 and a second magnetic mat of claim 1 comprising magnetically connecting the first and second magnetic mat together by positioning lateral face surfaces of the first and second magnetic mat adjacent each other so that the magnets of the first and second magnetic mat move within the respective pockets of the first and second magnetic mat to align and attract each other.

8. The magnetic mat of claim 1 wherein the N-sided three-dimensional shape is a cube.

9. The magnetic mat of claim 1 wherein the lateral face extends lengthwise about 17.5 inches or more and extends widthwise about 1 inch or more.

10. A magnetic mat comprising:
an insert made from a first material, at least one magnet, and a cover made from a second material wherein:
the cover is configured to enclose the insert and the at least one magnet;
the cover is removable from the insert;
the insert and the cover form a N-sided three-dimensional shape having a first base surface with N sides, a second base surface having N sides, and N lateral face surfaces wherein N is greater than or equal to three wherein the first base surface and the second base surface are on opposite sides of the mat and for each side of the N-sided three-dimensional shape, a lateral face extends widthwise between the edges of the first base surface and the second base surface and lengthwise from a first end of the side of the N-sided three-dimensional shape to a second end of the side of the N-sided three-dimensional shape;
the cover further comprises at least one pocket in a position coinciding with at least one of the lateral face surfaces wherein the at least one magnet is contained within the at least one pocket and the pocket is sized and shaped such that the at least one magnet is moveable widthwise and lengthwise along at least a part of the lateral face surface;
the at least one magnet is a rotating magnet and the pocket is sized and shaped such that the at least one magnet can rotate along an axis to line up with a nearby magnet; and
the insert is a foam material.

11. A magnetic mat comprising:
an insert made from a first material, a plurality of magnets, and a cover made from a second material wherein:
the cover is configured to enclose the insert and the plurality of magnets;
the cover is removable from the insert;
the insert and the cover form a N-sided three-dimensional shape having a first base surface with N sides, a second base surface having N sides, and N lateral face surfaces wherein N is greater than or equal to three wherein the first base surface and the second base surface are on opposite sides of the mat and for each side of the N-sided three-dimensional shape, a lateral face extends widthwise between the edges of the first base surface and the second base surface and lengthwise from a first end of the side of the N-sided three-dimensional shape to a second end of the side of the N-sided three-dimensional shape;
the cover further comprises a plurality of pockets in positions coinciding with a plurality of the lateral face surfaces wherein for each pocket, a magnet is contained within and the pocket is sized and shaped such that the magnet is moveable widthwise and lengthwise along at least a part of the lateral face surface and wherein at two of the plurality of pockets coincide with the same lateral face surface; and
the insert is a foam material.

12. A method of using a first magnetic mat of claim 10 and a second magnetic mat of claim 10 comprising magnetically connecting the first and second magnetic mat together by positioning lateral face surfaces of the first and second magnetic mat adjacent each other so that the magnets of the first and second magnetic mat move within the respective pockets of the first and second magnetic mat to align and attract each other.

13. A method of using a first magnetic mat of claim 11 and a second magnetic mat of claim 11 comprising magnetically connecting the first and second magnetic mat together by positioning lateral face surfaces of the first and second magnetic mat adjacent each other so that the magnets of the first and second magnetic mat move within the respective pockets of the first and second magnetic mat to align and attract each other.
